(19) United States
(12) Patent Application Publication
(10) Pub. No.: US 2022/0315090 A1
(43) Pub. Date: Oct. 6, 2022

(54) HANDLE

(71) Applicant: TOYODA GOSEI CO., LTD., Kiyosu-shi (JP)

(72) Inventors: Fumiyasu Kojima, Kiyosu-shi (JP); Takanori Yamada, Kiyosu-shi (JP)

(21) Appl. No.: 17/682,105

(22) Filed: Feb. 28, 2022

(30) Foreign Application Priority Data
Mar. 31, 2021 (JP) 2021-58994

(51) Int. Cl. B62D 1/06; B62D 1/04; B60Q 3/283; B60K 35/00

(52) U.S. Cl. CPC B62D 1/06; B62D 1/046; B60Q 3/283; B60K 35/00; B60K 2370/782; B60K 2370/33

(57) ABSTRACT

A handle includes a handle main body having a gripping portion, and a display device disposed at a position visible to a driver in the gripping portion. The display device is configured to be mounted to a mounted portion provided at the gripping portion, and configured such that a harness extending from the handle main body side is capable of being connected thereto. The harness has a harness-side connector to be connected to a display device-side connector, on the tip side exposed from a portion with a surface side covered with an outer skin layer covering the surface side of the gripping portion. A holding portion capable of holding an exposed portion exposed from the outer skin layer in the harness over a range from the base portion side to the tip side where the harness-side connector is disposed is formed on the display device side or the mounted portion side.

### CROSS REFERENCE TO RELATED APPLICATIONS

The present application claims priority from Japanese Patent Application No. 2021-58994 of Kojima et al., filed on Mar. 31, 2021, the entire disclosure of which is incorporated herein by reference.

### BACKGROUND

### 1. Technical Field

The present disclosure relates to a handle which includes a handle main body having a gripping portion to be gripped during steering, and a display device that is disposed at a position visible to a driver in the gripping portion.

### 2. Description of Related Art

In the related art, as a handle in which a display device is disposed in a gripping portion, as shown in JP-T-2010-537885, there is a handle having a configuration in which a harness extending from a handle main body is connected to a connector provided in a display device and the display device is electrically connected to the vehicle body side.

However, in the handle of the related art, in the harness extending from the handle main body, the tip side exposed from the portion with the surface side covered by an outer skin layer covering the surface side of the gripping portion is connected to the display device side, and therefore, in order to improve workability at the time of wire connection work, it is necessary to provide the harness with some margin for the length of an exposed portion exposed from the outer skin layer. However, in a case where the exposed portion of the harness is set to be long to some extent, after connection to the connector, a surplus occurs by an amount corresponding to the length set to be long. Therefore, when the display device after being connected to the connector is mounted to the handle main body, there is a concern that the harness may be caught between the display device and the handle main body so as to cause disconnection, and thus there is room for improvement in terms of improving handling workability of the exposed portion of the harness.

### SUMMARY

The present disclosure relates to a handle having the following configuration.

The handle includes a handle main body having a gripping portion to be gripped during steering; and a display device that is disposed at a position visible to a driver in the gripping portion,

in which the display device is configured to be mounted to a mounted portion provided at the gripping portion, and configured such that a harness extending from a handle main body side is capable of being connected thereto,

the harness is configured to have a harness-side connector to be connected to a display device-side connector, on a tip side that is exposed from a portion with a surface side covered with an outer skin layer covering a surface side of the gripping portion, and

a holding portion capable of holding an exposed portion exposed from the outer skin layer in the harness over a range from a base portion side to the tip side where the harness-side connector is disposed is formed on a display device side or a mounted portion side.

### BRIEF DESCRIPTION OF DRAWINGS

FIG. 1 is a plan view of a steering wheel according to an embodiment of the present disclosure.

FIG. 2 is a partially enlarged plan view showing a portion on the right end side (harness disposition side) of a light bar-side part of a ring portion in the steering wheel of the embodiment.

FIG. 3 is a sectional view of the steering wheel of the embodiment, and is a diagram corresponding to a portion along line III-Ill of FIG. 2.

FIG. 4 is a sectional view of the steering wheel of the embodiment, and is a diagram corresponding to a portion along line IV-IV of FIG. 2.

FIG. 5 is a sectional view of the steering wheel of the embodiment, and is a diagram corresponding to a portion along line V-V of FIG. 2.

FIG. 6 is a sectional view of the steering wheel of the embodiment, and is a vertical sectional view along a circumferential direction of the ring portion, showing the vicinity of the portion of a holding portion.

FIG. 7 is a partially enlarged plan view of a covering layer in the steering wheel of the embodiment.

FIG. 8 is a schematic perspective view showing a state where a unit main body of a light bar unit is placed on the covering layer and a harness is connected thereto, in the steering wheel of the embodiment.

FIG. 9A and FIG. 9B are schematic sectional views showing a state where a fitting protrusion portion formed on a cover portion is fitted into a fitting recess portion formed in the covering layer, in the steering wheel of the embodiment.

### DETAILED DESCRIPTION

Exemplary embodiments of the present disclosure are described below with reference to the accompanying drawings. However, the invention is not limited to the embodiments disclosed herein. All modifications within the appended claims and equivalents relative thereto are intended to be encompassed in the scope of the claims.

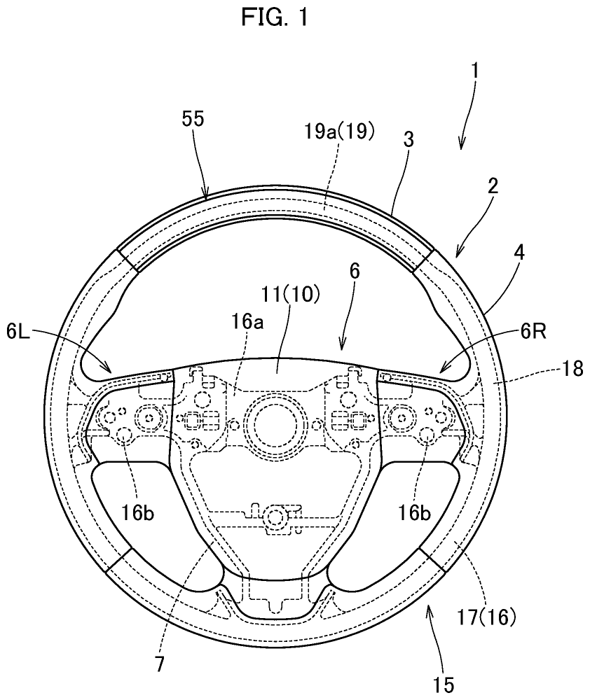

Hereinafter, an embodiment of the present disclosure will be described based on the drawings. In the embodiment, as a handle, a steering wheel 1 provided with an annular ring portion 2 (a gripping portion) will be taken as an example and described. As shown in FIG. 1, the steering wheel 1 has the annular ring portion 2 as a gripping portion to be gripped during rotary steering, a boss portion 7 that is disposed substantially in the center of the ring portion 2 and connected to a rotary shaft (not shown), and a spoke portion 6 that connects the ring portion 2 and the boss portion 7. Further, the steering wheel 1 is configured to include, as components, an airbag device 10 disposed at the upper portion of the boss portion 7, a light bar unit 55 as a display device that is disposed at the ring portion 2, and a steering wheel main body 15 as the handle main body. The ring portion 2 is composed of a light bar-side part 3 in which the light bar unit 55 is disposed, and a general portion 4 other than the light bar-side part 3. The light bar-side part 3 is composed of a front-side region between spoke portions 6L and 6R in the ring portion 2.

In the present specification, with regard to a front-rear direction, an up-down direction, and a right-left direction, unless otherwise specified, on the basis of a straight-ahead steering state of the steering wheel 1 in a state of being mounted on a vehicle, the direction along a rotation center axis (not shown) of the ring portion 2 is set to be the up-down direction, the direction perpendicular to the rotation center axis of the ring portion 2 and substantially along the front-rear direction of the vehicle is set to be the front-rear direction, and the direction perpendicular to the rotation center axis of the ring portion 2 and substantially along the right-left direction of the vehicle is set to be the right-left direction.

The airbag device 10 that is disposed at the upper portion of the boss portion 7 includes an airbag (not shown) that is folded and stored, an inflator (not shown) that supplies expansion gas to the airbag, and a pad 11 that covers the upper surface side of the folded airbag. As shown in FIG. 1, the pad 11 is disposed so as to cover the entire upper surface side of the boss portion 7.

As shown in FIGS. 1, 2, 4, and 5, the steering wheel main body 15 includes a core metal 16 that is disposed so as to connect the ring portion 2, the boss portion 7, and the spoke portions 6 to each other, a covering layer 30 that covers the periphery of the core metal 16, an outer skin layer 50 that covers the outer peripheral surface side of the covering layer 30, a lower cover (not shown) that covers the lower surface side of the boss portion 7, and a harness 25 that electrically connects an operation control circuit (not shown) that is provided on the vehicle body side and the light bar unit 55. The covering layer 30 is disposed so as to cover the peripheries of the ring portion 2 and the ring portion 2 side portion of the spoke portion 6 in the core metal 16.

The core metal 16 is made of metal such as an aluminum alloy. As shown in FIG. 1, the core metal 16 includes a boss portion core metal 16a that is disposed at the portion of the boss portion 7, a spoke portion core metal 16b that is disposed at the portion of the spoke portion 6, and a ring portion core metal 17 that is disposed at the portion of the ring portion 2.

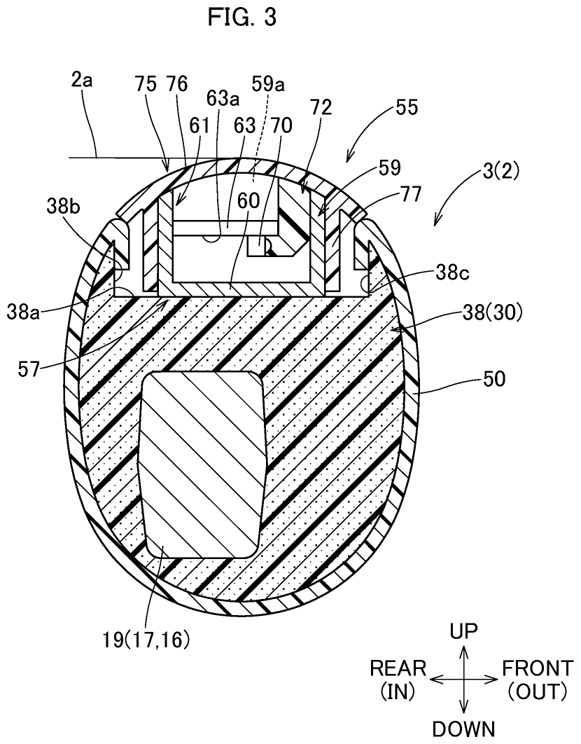

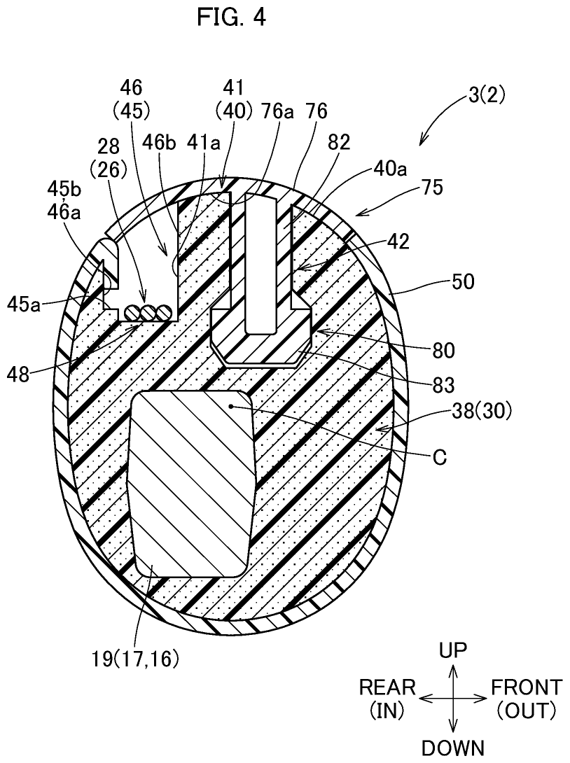

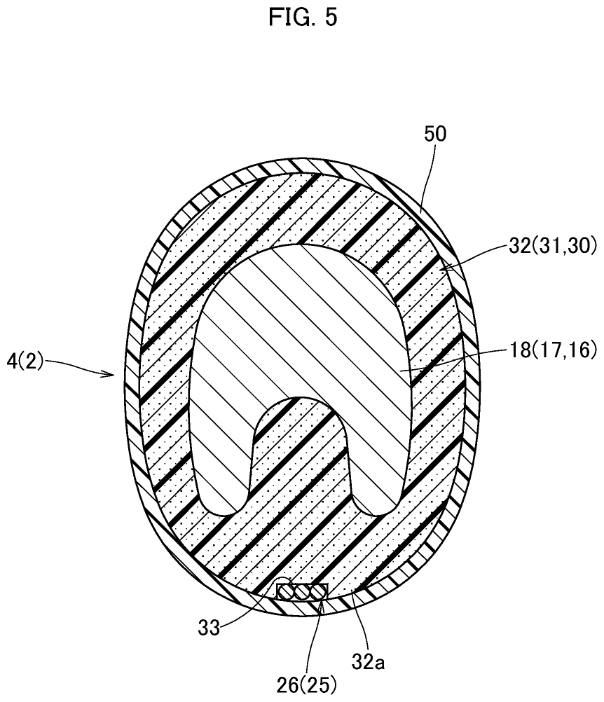

In the case of the embodiment, the ring portion core metal 17 is composed of a light bar disposition portion 19 disposed on the light bar unit 55 as the display device and a general portion 18 that is disposed at the portion of the general portion 4 of the ring portion 2. The light bar disposition portion 19 is disposed at the light bar-side part 3 between the spoke portions 6L and 6R in the ring portion 2. Specifically, the general portion 18 is disposed at a region of the general portion 4 excluding the light bar-side part 3 in the ring portion 2, and in the case of the embodiment, the general portion 18 is disposed at a region that extends to regions slightly forward of the left and right spoke portions 6L and 6R. The general portion 18 is configured to be curved in a substantially inverted U-shape in a cross section (refer to FIG. 5). The light bar disposition portion 19 that is disposed in the disposition region for the light bar unit 55 has a cross-sectional shape in which the width dimensions in the up-down and front-rear directions are set to be smaller than those of the general portion 18 and which is configured as a substantially rectangular shape made wide on the up-down direction side. Specifically, the light bar disposition portion 19 is disposition in a region of about the lower half of the ring portion 2 so as to suppress interference with the light bar unit 55 that is disposition on the upper portion side of the ring portion 2 (refer to FIGS. 3 and 4).

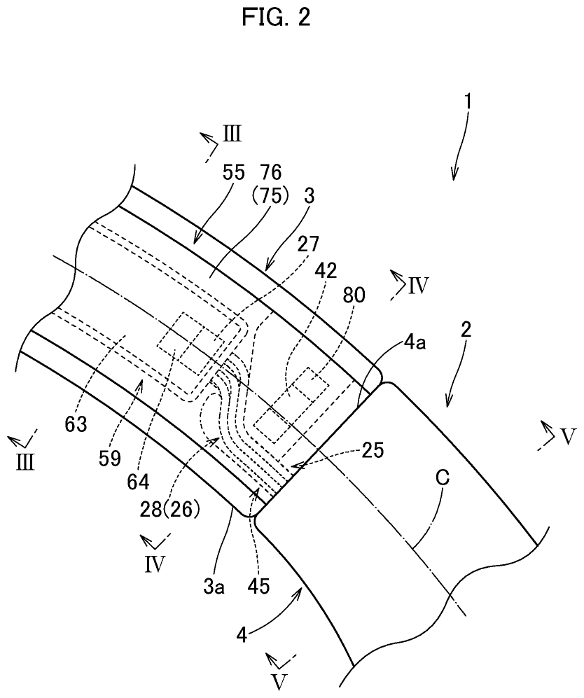

Although detailed illustration is omitted, the harness 25 that electrically connects the light bar unit 55 to an operation control circuit (not shown) is disposed so as to pass through the lower surface side of the steering wheel 1 from the right spoke portion 6R to the right front-side region in the ring portion 2 via the region of the boss portion 7. In the case of the embodiment, the harness 25 includes a harness main body 26 which is composed of three flexible linear bodies that are arranged side by side, and a harness-side connector 27 that is connected to a light bar-side connector 64 (a display device-side connector) (described later) which is provided on the tip side (refer to FIGS. 2, 4, 6, and 8). In harness 25, in a state before the light bar unit 55 is mounted, the harness-side connector 27 and the portion of the harness main body 26 in vicinity of the harness-side connector 27 are exposed from a terminal 4a of the general portion 4 of the ring portion 2. In the harness 25, the remaining portion that is disposed in the region of the general portion 4 is accommodated in an accommodation recess groove 33 of a general portion-side portion 31 and a recess groove 36 of a boundary-side portion 35 (described later), and the surface side is covered with the outer skin layer 50 (described later) covering the surface side of the ring portion 2 (refer to FIG. 5).

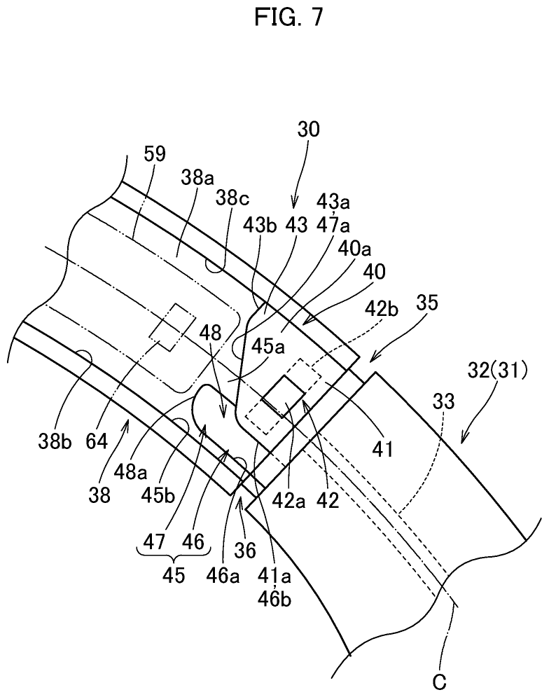

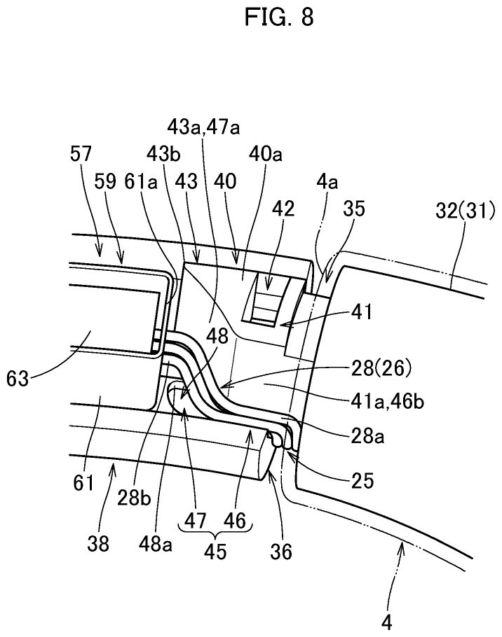

The covering layer 30 is formed of a soft synthetic resin having cushioning properties, and in the case of the embodiment, it is formed of a soft foaming material such as polyurethane foam. The covering layer 30 is configured to cover the outer periphery side of the ring portion core metal 17 (the general portion 18 and the light bar disposition portion 19) at the portion of the ring portion 2, as shown in FIGS. 3 to 5. The covering layer 30 includes the general portion-side portion 31 that covers the outer periphery side of the general portion 18, a light bar-side portion 38 that covers the outer periphery side of the light bar disposition portion 19, and the boundary-side portion 35 that configures the boundary between the general portion-side portion 31 and the light bar-side portion 38. In the covering layer 30, the general portion-side portion 31 that covers the outer periphery side of the general portion 18 has a substantially elliptical cross-sectional shape made wide on the up-down direction side. Further, in the general portion-side portion 31, the accommodation recess groove 33 for inserting the harness main body 26 of the harness 25 is formed on the lower end 32a side of a right front-side portion 32 which is the region between the right spoke portion 6R and the boundary-side portion 35. The accommodation recess groove 33 is formed continuously along the circumferential direction of the ring portion 2 such that the lower surface side thereof is recessed upward (refer to FIGS. 5 and 7). In the boundary-side portion 35, the recess groove 36 for fitting a terminal (not shown) of the outer skin layer 50 is formed continuously over the entire area along the circumferential direction of the cross section of the ring portion 2 (refer to FIGS. 7 and 8). The recess groove 36 is formed so as to be continuous with the accommodation recess groove 33 that is formed in the general portion-side portion 31. Then, the harness main body 26 is inserted into the accommodation recess groove 33 and an inner lower-side region of the recess groove 36 (refer to FIGS. 5 and 8).

The light bar-side portion 38 that covers the outer periphery side of the light bar disposition portion 19 configures a mounted portion for mounting the light bar unit 55. The light bar-side portion 38 is formed by being recessed so as to open the upper side such that the light bar unit 55 can be accommodated, and as shown in FIG. 3, a bottom surface 38a is configured to be substantially parallel to a ring plane 2a of the ring portion 2. A case 59 (described later) of the light bar unit 55 is placed on the bottom surface 38a of the light bar-side portion 38. The light bar-side portion 38 is formed so as to rise upward from the bottom surface 38a to be provided with an inner side surface 38b and an outer side surface 38c which are disposed on the sides (the inner side and the outer side) of the case 59 of the light bar unit 55 (refer to FIGS. 3 and 7). As shown in FIGS. 7 and 8, mounting portions 40 for mounting a cover portion 75 (described later) of the light bar unit 55 are formed on both end sides on the longitudinal direction side in the light bar-side portion 38 (the circumferential direction side of the ring portion 2). Further, a holding portion 45 capable of holding an exposed portion 28 (described later) of the harness 25 is adjacent to the mounting portion 40 on the right end side of the light bar-side portion 38, which is the side on which the harness 25 is disposed.

The mounting portion 40 is disposed at each position on the outer side (front side) on both end sides in the longitudinal direction of the light bar-side portion 38. The mounting portion 40 is configured so as to be partially raised from the bottom surface 38a of the light bar-side portion 38 such that an upper surface 40a can come into contact with the back surface 76a side of an upper wall portion 76 (described later) of the cover portion 75. In the embodiment, the mounting portion 40 on the right end side (the harness 25 disposition side) in the light bar-side portion 38 is taken as an example and described in detail. Although detailed illustration is omitted, the mounting portion 40 on the left end side has the same configuration as the mounting portion 40 on the right end side except that the holding portion is not adjacent thereto.

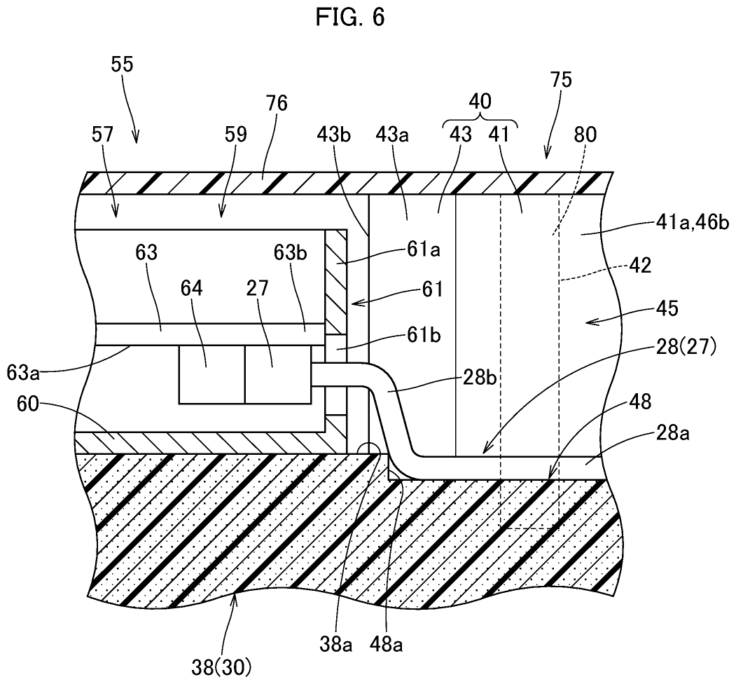

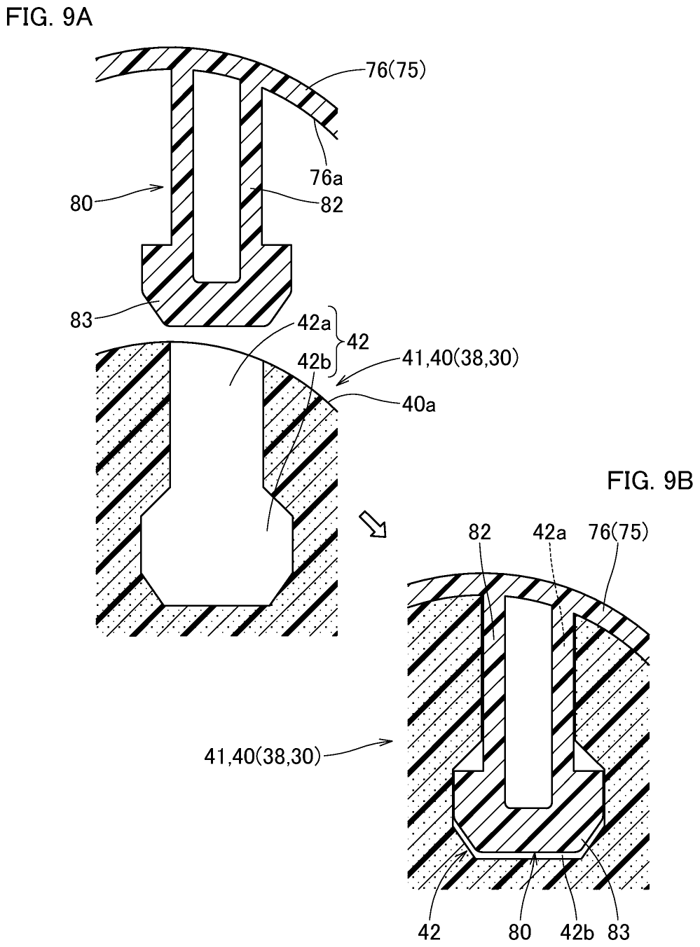

The mounting portion 40 is formed so as to be continuous with the outer side surface 38c of the light bar-side portion 38, and is configured such that the upper surface 40a is curved substantially along the back surface 76a of the upper wall portion 76 of the cover portion 75 to be capable of coming into contact with the upper wall portion 76 (refer to FIGS. 4 and 8). A fitting recess portion 42 for fitting a fitting protrusion portion 80 that is formed so as to protrude downward from the upper wall portion 76 of the cover portion 75 is formed in the mounting portion 40. Specifically, the fitting recess portion 42 is formed so as to be recessed downward from the upper surface 40a of the mounting portion 40 at a terminal-side portion 41 which is the right end side in the mounting portion 40 (the spoke portion 6R side, that is, the terminal side of the cover portion 75). The fitting recess portion 42 is formed corresponding to the fitting protrusion portion 80 such that the opening shape when viewed from above is a substantially rectangular shape in which the longitudinal direction thereof is substantially along an inward-outward direction (the front-rear direction) which is the direction orthogonal to the axis of the ring portion 2 (refer to FIGS. 7 and 8). The fitting recess portion 42 is configured to have an opening on the upper end side such that the fitting protrusion portion 80 can be inserted from above, and as shown in FIG. 6, the outer shape in a state of being viewed from the inner side of the ring portion 2 is configured so as to have a width dimension that is substantially constant over the entire area in the up-down direction. Further, the fitting recess portion 42 is configured such that the cross-sectional shape on the direction side along the cross section of the ring portion is narrow on the upper end side and wide on the lower end side (refer to FIGS. 4 and 9). The opening width dimension of a narrow width portion 42a on the upper end side of the fitting recess portion 42 is set to a dimension to allow a neck portion 82 (described later) of the fitting protrusion portion 80 to be inserted. The width dimension of a wide width portion 42b on the lower end side of the fitting recess portion 42 is set to a dimension to allow a head portion 83 (described later) of the fitting protrusion portion 80 to be inserted. Then, the boundary portion between the narrow width portion 42a and the wide width portion 42b is configured to be widened in a tapered shape toward the wide width portion 42b, as shown in FIG. 9A. Further, in the mounting portion 40, the outer shape of a center-side portion 43 which is a region on the left side (the light bar unit 55 side) of the terminal-side portion 41 in which the fitting recess portion 42 is disposed, is a substantially triangular shape that converges toward the left end side in which is viewed from up-down direction side. Specifically, the terminal of the center-side portion 43 converges toward the outer side surface 38c of the light bar-side portion 38.

The holding portion 45 is for holding the exposed portion 28 exposed from the outer skin layer 50 in the harness 25 in a state where the harness-side connector 27 is connected to the light bar-side connector 64 side. The holding portion 45 is composed of a region inside the mounting portion 40 on the right end side of the light bar-side portion 38. Specifically, in the case of the embodiment, as shown in FIGS. 4 and 6 to 8, the holding portion 45 is composed of a region surrounded by a bottom surface 45a and an inner side surface 45b, which are disposed so as to be continuous from the bottom surface 38a and the inner side surface 38b of the light bar-side portion 38, and the mounting portion 40. Further, the holding portion 45 communicates with the recess groove 36 formed in the boundary-side portion 35 such that the harness main body 26 can be inserted. The holding portion 45 is configured to have an base portion-side portion 46, which holds the base portion 28a side of the exposed portion 28 of the harness 25, and a tip-side portion 47 that is configured to expand from the base portion-side portion 46 and allows the tip 28b side (the harness-side connector 27 side) of the exposed portion 28 to be inserted, and is configured such that the base portion-side portion 46 is disposed at a position on the inner side with respect to a cross-sectional center C of the ring portion 2 (on the inner edge 3a side of the light bar-side part 3) when viewed in a plan view (refer to FIGS. 2, 4, and 7). The base portion-side portion 46 is composed of a region surrounded by a side surface 41a of the terminal-side portion 41 in the mounting portion 40, the bottom surface 45a, and the inner side surface 45b. In the base portion-side portion 46, the side surface 41a of the terminal-side portion 41 and the inner side surface 45b, which are disposed so as to face each other in the inward-outward direction, serve as restriction surfaces 46a and 46b that restrict the movement of the exposed portion 28 of the harness main body 26 accommodated inside to the inward-outward direction side (the inner periphery-side direction and outer periphery-side direction of the ring portion 2) on the base portion 28a side. In the base portion-side portion 46, the separation distance between the restriction surfaces 46a and 46b is set to be slightly larger than the width dimension of the harness main body 26 such that the harness main body 26 (the exposed portion 28) can be smoothly inserted (refer to FIG. 4). The tip-side portion 47 is composed of a region surrounded by a side surface 43a of the center-side portion 43 in the mounting portion 40, the bottom surface 45a, and the inner side surface 45b. The side surface 43a of the center-side portion 43 configuring the tip-side portion 47 is configured to be disposed to be inclined when viewed in a plan view such that an end edge 43b on the side separated from the terminal-side portion 41 is connected to the outer side surface 38c of the light bar-side portion 38. The end edge 43b is disposed at a position near the right end of the case 59 (near a right wall portion 61a) of the light bar unit 55 (refer to FIGS. 7 and 8). That is, the side surface 43a of the center-side portion 43 configures a guide surface 47a that guides the exposed portion 28 (the harness main body 26) that is disposed so as to protrude from the right wall portion 61a of the case 59 when the exposed portion 28 is held in the holding portion 45 in a state where the harness-side connector 27 is connected to the light bar-side connector 64 disposed in the case 59. Then, by disposing the tip 28b side of the exposed portion 28 along the guide surface 47a (the side surface 43a), it is possible to stably hold the portion on the base portion 28a side of the exposed portion 28 between the restriction surfaces 46a and 46b of the base portion-side portion 46.

Further, a recess portion 48 for restricting the exposed portion 28 is formed on the bottom surface 45a of the holding portion 45. The recess portion 48 is configured such that in a state of being viewed in a plan view, the end edge 48a on the light bar unit 55 side is curved in a substantially arc shape to cause the bottom surface 45a to be recessed downward over substantially the entire area (refer to FIGS. 6 and 7). By disposing the recess portion 48, it is possible to increase the substantial depth (vertical width dimension) of the holding portion 45. Further, the movement of the exposed portion 28 (the harness main body 26) to the light bar unit 55 side can also be restricted by the end edge 48a (refer to FIG. 6) on the light bar unit 55 side in the recess portion 48. The holding portion 45 is configured to be capable of holding the exposed portion 28 of the harness 25 exposed between a unit main body 57 (described later) of the light bar unit 55 and the terminal 4a of the general portion 4 of the ring portion 2 in a state where the harness-side connector 27 on the tip side is connected to the light bar-side connector 64 provided on the substrate 63 side of the unit main body 57. In the holding portion 45, the base portion-side portion 46 that holds the base portion 28a of the exposed portion 28 is disposed at a position shifted to the inside (the rotation center side of the steering wheel 1) with respect to the light bar-side connector 64 in the light bar unit 55 when viewed in a plan view (refer to FIG. 7). Then, the exposed portion 28 has a configuration in which it is curved so as to be guided by the guide surface 47a of the tip-side portion 47 and is accommodated in the holding portion 45 while the inside and outside of the base portion 28a side are restricted by the restriction surfaces 46a and 46b of the base portion-side portion 46 (refer to FIGS. 2 and 8). Therefore, it is possible to make the exposed portion 28 longer by an amount corresponding to the curve as compared with a case where the harness main body 26 is disposed linearly when viewed in a plan view. Further, since the holding portion 45 has the recess portion 48 disposed on the bottom surface 45a, even if a surplus further occurs in the length of the exposed portion 28, the exposed portion 28 can be held in the holding portion 45 while being curved on the up-down direction side.

The outer skin layer 50 that covers the outer peripheral surface side of the covering layer 30 is configured to cover the entire outer peripheral surface of the general portion-side portion 31. The outer skin layer 50 is configured to cover the entire surface of the light bar-side portion 38 except for the disposition region for the cover portion 75 (described later) in the light bar unit 55 (refer to FIGS. 3 and 4). In the case of the embodiment, the outer skin layer 50 is formed of a sheet body made of synthetic resin or leather such as natural leather, synthetic leather, or artificial leather.

The light bar unit 55 as a display device is configured to have a substantially long shape that is curved and disposed substantially along the ring portion 2, and in the case of the embodiment, the light bar unit 55 is disposed so as to be exposed on the upper surface side of the light bar-side part 3 between the left and right spoke portions 6L and 6R in the ring portion 2. Specifically, the light bar unit 55 has a substantially band shape in which the outer shape when viewed from above is curved such that the longitudinal direction thereof substantially follows the circumferential direction of the ring portion 2, and is continuously formed in the region of about ¼ of the ring portion 2.

As shown in FIG. 3, the light bar unit 55 includes the unit main body 57 and the cover portion 75 that covers the upper surface side of the unit main body 57. The unit main body 57 includes the case 59, the substrate 63 that is accommodated and held in the case 59, a visible light LED 70 (a visible light source) that is mounted on the substrate 63 and capable of lighting at the time of an operation, and a light guide body 72 that radiates the visible light emitted from the visible light LED 70 to the cover portion 75 side.

In the case of the embodiment, as shown in FIGS. 3, 6, and 8, the case 59 has a substantially box shape in which the upper side is open, so that a radiation opening 59a capable of radiating the visible light at the time of an operation is disposed on the upper end side. The case 59 includes a curved strip-shaped bottom wall portion 60 and a peripheral wall portion 61 extending upward from the outer peripheral edge of the bottom wall portion 60. An insertion opening 61b through which the harness-side connector 27 disposed on the tip side of the harness main body 26 can be inserted is formed in the right wall portion 61a disposed on the right end side of the case 59 in the peripheral wall portion 61 (refer to FIG. 6).

The substrate 63 is disposed substantially along the front-rear direction in the case 59 so as to substantially follow the opening surface of the radiation opening 59a (the bottom wall portion 60 of the case 59). In the case of the embodiment, the substrate 63 is disposed so as to provide a gap between itself and the bottom wall portion 60 (refer to FIGS. 3 and 6), and is mounted to the case 59 at a predetermined location. Further, the light bar-side connector 64 that can be connected to the harness-side connector 27 formed on the tip side of the harness 25 is disposed on the back surface 63a side on the right end 63b side in the substrate 63 (refer to FIG. 6). Specifically, the light bar-side connector 64 is disposed such that the center thereof substantially coincides with the center in the width direction of the case 59 and substantially coincides with the cross-sectional center C of the ring portion 2 (refer to FIGS. 2 and 7). The visible light LED 70 (the visible light source) is capable of emitting a predetermined color at the time of an operation, and a plurality of visible light LEDs 70 (visible light sources) are arranged side by side substantially along the longitudinal direction on the back surface 63a side of the substrate 63. Each of the visible light LEDs 70 is mounted so as to be capable of emitting visible light toward the outside (the front) that is the light guide body 72 side, and is configured such that an operation thereof is controlled by an operation circuit (not shown). As shown in FIG. 3, the light guide body 72 is disposed on the front side (the outside side) of the substrate 63 in the case 59, and is bent so as to extend upward while extending forward from the front side of the visible light LED 70, so that it has a plate shape having a substantially L-shaped cross section. The light guide body 72 emits the visible light emitted from the visible light LED 70 from the upper end side toward the upper side, which is the radiation opening 59a side (the cover portion 75 side), while internally deflecting the visible light, and is formed of synthetic resin such as polycarbonate resin or acrylic resin.

The unit main body 57 is mounted on the light bar-side portion 38 of the covering layer 30 in a state where the substrate 63 on which the visible light LED 70 is disposed and the light guide body 72 are accommodated and integrated in the case 59. Specifically, the unit main body 57 is mounted on the light bar-side portion 38 (the mounted portion) by placing the case 59 on the bottom surface 38a of the light bar-side portion 38 of the covering layer 30 and mounting a predetermined location (not shown) to the light bar-side portion 38 side. Further, the unit main body 57 (the case 59) is disposed such that the center thereof in the width direction substantially coincides with the cross-sectional center C of the ring portion 2 (refer to FIGS. 2, 3, and 7).

The cover portion 75 is configured to cover the entire upper surface side of the entire unit main body 57. The cover portion 75 includes the upper wall portion 76 that is exposed on the surface of the ring portion 2, a side wall portion 77 that is formed so as to protrude downward from the back surface 76a side of the upper wall portion 76 and disposed so as to cover the inner side surface and the outer side surface of the case 59, and the fitting protrusion portions 80, 80 that are disposed on both end sides in the longitudinal direction. In the case of the embodiment, the cover portion 75 is made of a transparent black synthetic resin having translucency in accordance with the black outer skin layer 50, and is configured to be capable of transmitting the visible light emitted from the visible light LED 70. The upper wall portion 76 covers the radiation opening 59a of the case 59, and is formed such that the upper surface thereof is curved so as to be gently connected to the outer surface of the outer skin layer 50. The upper wall portion 76 is formed to extend from both ends in the longitudinal direction of the unit main body 57 to both sides in the longitudinal direction (the outside on the circumferential direction side of the ring portion 2) so as to cover the upper surface side of the light bar-side portion 38 of the covering layer 30 including the portion of the mounting portion 40 as well. The fitting protrusion portions 80 that can be fitted into the fitting recess portions 42 formed in the mounting portion 40 are disposed on both end sides of the upper wall portion 76 that covers the portion of the mounting portion 40.

The fitting protrusion portions 80 are disposed one by one on both end sides of the upper wall portion 76 (the cover portion 75), and are each formed so as to protrude downward from the back surface 76a side of the upper wall portion 76. The fitting protrusion portion 80 is configured such that the thickness dimension thereof is substantially constant, and is disposed such that the width direction thereof substantially follows the width direction of the upper wall portion 76 (refer to FIG. 2). Further, as shown in FIGS. 4 and 9, the fitting protrusion portion 80 includes the neck portion 82 and the head portion 83 formed so as to bulge from the neck portion 82 on the tip side of the neck portion 82. The neck portion 82 is inserted through the narrow width portion 42a on the upper end side of the fitting recess portion 42, and the width dimension thereof is set to a dimension capable of being inserted into the narrow width portion 42a. The width dimension of the head portion 83 is set to be larger than that of the neck portion 82, that is, is set to a dimension larger than that of the narrow width portion 42a, and is set to a dimension capable of being accommodated in the wide width portion 42b of the fitting recess portion 42. As described above, the fitting recess portion 42 into which the fitting protrusion portion 80 is inserted is formed by recessing the upper surface 40a side of the mounting portion 40 in the covering layer 30 made of a soft foaming material. Therefore, when the fitting protrusion portion 80 is inserted, as shown in FIG. 9A, even if the width dimension of the head portion 83 is set to be larger than that of the narrow width portion 42a, the head portion 83 can be inserted into the narrow width portion 42a by compressing the opening peripheral edge of the fitting recess portion 42. Then, when the head portion 83 has reached the wide width portion 42b, the compressed region of the opening peripheral edge of the fitting recess portion 42 is restored so as to cover the upper side of the head portion 83, so that the fitting protrusion portion 80 can be fitted into the fitting recess portion 42 (refer to FIG. 9B).

The manufacturing procedure of the steering wheel 1 of the embodiment will be described. The airbag device 10 is assembled to the steering wheel main body 15 manufactured in advance. At the same time, the unit main body 57 of the light bar unit 55 is mounted to the steering wheel main body 15. At this time, the harness-side connector 27 disposed on the tip 28b side of the harness 25 (the exposed portion 28) exposed from the outer skin layer 50 on the terminal 4a side of the general portion 4 of the ring portion 2 is connected to the light bar-side connector 64 disposed in the case 59 of the unit main body 57. The unit main body 57 is placed on the bottom surface 38a of the light bar-side portion 38 of the covering layer 30. Then, a predetermined location (not shown) of the case 59 is mounted to the light bar-side portion 38 side. Thereafter, the exposed portion 28 of the harness 25 exposed between the case 59 and the terminal 4a of the general portion 4 of the ring portion 2 is fitted from above to be accommodated and held in the holding portion 45 formed in the light bar-side portion 38 of the covering layer 30. Thereafter, when the cover portion 75 is put on from above so as to cover the unit main body 57, and the fitting protrusion portion 80 is inserted into the fitting recess portion 42, so that the cover portion 75 is mounted to the covering layer 30 (the light bar-side portion 38) side, the steering wheel 1 can be manufactured.

Then, in the steering wheel 1 (the handle) of the embodiment, the holding portion 45 capable of holding the exposed portion 28 exposed from the outer skin layer 50 in the harness 25 is formed on the light bar-side portion 38 (the mounted portion) side of the covering layer 30 in the steering wheel main body 15 (the handle main body) to which the light bar unit 55 as a display device is mounted. That is, the length dimension of the exposed portion 28 of the harness 25 can be set to be longer by an amount corresponding to the portion that can be held by the holding portion 45. Therefore, it is possible to easily perform the connection work for connecting the harness-side connector 27 provided on the tip side of the harness 25 to the light bar-side connector 64 (the display device-side connector) disposed at the light bar unit 55 (the unit main body 57) in a state before being mounted to the light bar-side portion 38. Then, the harness 25 having the tip side connected to the light bar unit 55 side is configured such that the exposed portion 28 can be held by the holding portion 45 over a range from the base portion 28a side to the tip 28b side where the harness-side connector 27 is disposed. Therefore, if the exposed portion 28 is held by the holding portion 45, when the light bar unit 55 is mounted to the light bar-side portion 38 of the covering layer 30, the movement of the exposed portion 28 that tries to enter between the light bar unit 55 and the steering wheel main body 15 (the handle main body) can be suppressed, so that the exposed portion 28 (the harness main body 26) is restrained from being bitten. As a result, the light bar unit 55 can be easily mounted to the light bar-side portion 38 of the covering layer 30 without the exposed portion 28 of the harness 25 hindering the mounting work. Specifically, in the steering wheel 1 of the embodiment, after the unit main body 57 of the light bar unit 55 is placed on the light bar-side portion 38 of the covering layer 30 and mounted to the light bar-side portion 38, and then the cover portion 75 that covers the unit main body 57 is put on from above the unit main body 57 and mounted to the light bar-side portion 38. The exposed portion 28 is held by the holding portion 45 at the time of the work of mounting the cover portion 75 to the light bar-side portion 38. Therefore, the exposed portion 28 can be restrained from being bitten between the cover portion 75 and the light bar-side portion 38, so that the cover portion 75 can be smoothly mounted to the light bar-side portion 38 without hindering the mounting work.

Therefore, in the steering wheel 1 of the embodiment, the handling workability of the harness 25 that is connected to the light bar unit 55 as a display device is good.

In particular, in the steering wheel 1 of the embodiment, the fitting protrusion portion 80 provided at the cover portion 75 is inserted into the fitting recess portion 42 provided in the mounting portion 40 that is disposed in the vicinity of the region where the harness main body 26 is disposed. However, in the steering wheel 1 of the embodiment, since the harness main body 26, that is, the exposed portion 28 can be held by the holding portion 45, even in a configuration in which the mounting portion 40 is adjacent to the holding portion 45, it is possible to suppress the occurrence of biting that causes disconnection, due to the exposed portion 28 of the harness 25 being sandwiched between the cover portion 75 (the upper wall portion 76) and the mounting portion 40 at the time of mounting of the cover portion 75. As a result, the cover portion 75 can be smoothly mounted to the light bar-side portion 38.

Further, in the steering wheel 1 of the embodiment, the holding portion 45 is configured to be able to restrict the movement of the exposed portion 28 of the harness 25 to the inward-outward direction side of the ring portion 2 (both sides in the direction orthogonal to the axis of the ring portion 2). Therefore, the exposed portion 28 of the harness 25 can be fitted from above and held by the holding portion 45. As a result, the exposed portion 28 of the harness 25 can be easily assembled to the holding portion 45, and due to the holding portion 45, the exposed portion 28 of the harness 25 can also be accurately restrained from protruding from the ring portion 2. Further, in the steering wheel 1 of the embodiment, the recess portion 48 recessed further downward is formed on the bottom surface 45a of the holding portion 45. Therefore, it is possible to increase the substantial width dimension on the up-down direction side of the holding portion 45. As a result, even in an aspect in which a surplus occurs in the length of the exposed portion 28 and the exposed portion 28 is curved on the up-down direction side in the holding portion 45, the movement of the exposed portion 28 to the inward-outward direction side can be stably restricted.

In the steering wheel 1 of the embodiment, as the light bar unit 55, a configuration is used in which the cover portion 75 is mounted to the light bar-side portion 38 (the mounted portion) of the covering layer 30 separately from the unit main body 57. However, as the light bar unit (the display device), a configuration may be used in which the cover portion is mounted to the light bar-side portion in a state where the cover portion is integrated with the case in advance.

Further, in the embodiment, as the handle, the steering wheel 1 configured to have the annular ring portion 2 as the gripping portion is taken as an example and described. However, the handle to which the present disclosure can be applied is not limited to the embodiment. Further, in the steering wheel 1 of the embodiment, the light bar unit 55 is provided as a display device. However, as the display device, for example, a switch or the like that is disposed to be exposed on the surface of the ring portion (the gripping portion) can also be exemplified. Further, in the embodiment, the holding portion 45 is formed at the light bar-side portion 38 of the covering layer 30 as the mounted portion to which the light bar unit 55 is mounted. However, the position of the holding portion is not limited to the embodiment. A configuration may be made in which the holding portion is disposed on the back surface side of the light bar unit (the display device).

The present disclosure relates to a handle having the following configuration.

The handle includes a handle main body having a gripping portion to be gripped during steering; and a display device that is disposed at a position visible to a driver in the gripping portion,

in which the display device is configured to be mounted to a mounted portion provided at the gripping portion, and configured such that a harness extending from a handle main body side is capable of being connected thereto,

the harness is configured to have a harness-side connector to be connected to a display device-side connector, on a tip side that is exposed from a portion with a surface side covered with an outer skin layer covering a surface side of the gripping portion, and

a holding portion capable of holding an exposed portion exposed from the outer skin layer in the harness over a range from a base portion side to the tip side where the harness-side connector is disposed is formed on a display device side or a mounted portion side.

In the handle according to the present disclosure, the holding portion capable of holding the exposed portion exposed from the outer skin layer in the harness is formed on the display device side to which the harness is connected or the mounted portion side of the handle main body to which the display device is mounted. Then, the length dimension of the exposed portion of the harness can be set to be longer by an amount corresponding to the portion that can be held by the holding portion. Therefore, it is possible to easily perform the connection work of connecting the harness-side connector provided on the tip side of the harness to the display device-side connector disposed in the display device in a state before being mounted to the mounted portion. Then, the harness having the tip side connected to the display device side is configured such that the exposed portion can be held by the holding portion over a range from the base portion side to the tip side where the harness-side connector is disposed. Therefore, if the exposed portion is held by the holding portion, when the display device is mounted to the mounted portion, the movement of the exposed portion that tries to enter between the display device and the handle main body can be suppressed, so that the exposed portion (the harness) is restrained from being bitten. As a result, the display device can be easily mounted to the mounted portion without the exposed portion of the harness hindering the mounting work.

Therefore, in the handle according to the present disclosure, the handling workability of the harness that is connected to the display device is good.

Further, in the handle according to the present disclosure, if the holding portion is configured to be capable of restricting the movement of the exposed portion of the harness in the inner periphery-side direction and the outer periphery-side direction of the gripping portion, the exposed portion of the harness can be fitted from above and held by the holding portion, so that assembling of the exposed portion of the harness to the holding portion becomes easy. Further, protrusion of the exposed portion of the harness from the gripping portion can be accurately suppressed by the holding portion, which is preferable.

What is claimed is:

1. A handle comprising:
a handle main body having a gripping portion to be gripped during steering; and
a display device that is disposed at a position visible to a driver in the gripping portion,
wherein the display device is configured to be mounted to a mounted portion provided at the gripping portion, and configured such that a harness extending from the handle main body side is capable of being connected thereto,
the harness is configured to have a harness-side connector to be connected to a display device-side connector, on a tip side that is exposed from a portion with a surface side covered with an outer skin layer covering a surface side of the gripping portion, and
a holding portion capable of holding an exposed portion exposed from the outer skin layer in the harness over a range from a base portion side to the tip side where the harness-side connector is disposed is formed on the display device side or the mounted portion side.

2. The handle according to claim 1, wherein the holding portion is configured to be able to restrict a movement of the exposed portion of the harness in an inner periphery-side direction and an outer periphery-side direction of the gripping portion.

3. The handle according to claim 2, wherein the holding portion is formed on the mounted portion side.

4. The handle according to claim 3, wherein the display device includes a light bar unit.

5. The handle according to claim 4, wherein the light bar unit is configured to include a unit main body and a cover portion that covers the unit main body, and
the cover portion is configured to be mounted to the mounted portion by mounting the unit main body on the mounted portion side and then covering the unit main body with the cover portion from an outside of the unit main body.

6. The handle according to claim 5, wherein the cover portion is mounted to a mounting portion that is disposed adjacent to the holding portion at the mounted portion.

7. The handle according to claim 3, wherein the holding portion includes a recess portion further recessed on a bottom surface side.
